(19) United States
(12) Patent Application Publication
(10) Pub. No.: US 2016/0068395 A1
(43) Pub. Date: Mar. 10, 2016

(54) Methods and Devices for the Synthesis of Metallofullerenes

(71) Applicant: LUNA INNOVATIONS INCORPORATED, Roanoke, VA (US)

(72) Inventor: Valeriy Nikolaevich Bezmelnitsyn, Danville, VA (US)

(73) Assignee: LUNA INNOVATIONS INCORPORATED, Roanoke, VA (US)

(21) Appl. No.: 14/777,472

(22) PCT Filed: Mar. 14, 2014
(86) PCT No.: PCT/US14/26905

§ 371 Date: Sep. 15, 2015

Related U.S. Application Data
(60) Provisional application No. 61/793,949, filed on Mar. 15, 2013.

(51) Int. Cl. C01B 31/02; B01J 19/08

(52) U.S. Cl. CPC C01B 31/0213; B01J 19/088; B01J 2219/0809; B01J 2219/0816; B01J 2219/0839; B01J 2219/0871

(57) ABSTRACT

Methods and apparatuses for the production of metallofullerenes using an arc discharge reactor setup are described. The metallofullerenes are produced by evaporation in an AC arc discharge of multiple, angle positioned, solid graphite electrodes and of a powder of the metal, to be incorporated in carbon cage, injected in the arc discharge independently.

### CROSS-REFERENCE TO RELATED APPLICATION

This application is a Patent Cooperation Treaty (PCT) International Application claiming the benefit under 35 USC 119(e) of and priority to U.S. Provisional Patent Application No. 61/793,949, entitled “Methods and Devices for the Synthesis of Metallofullerenes,” filed Mar. 15, 2013, (Attorney Docket No. 0022-00173 US PV), of common assignee to the present invention, the contents of which is incorporated herein by reference in its entirety.

### GOVERNMENT LICENSE RIGHTS

The experiments performed in this application were supported in part by Grant No. DE-SC0003537 awarded by the U.S. Department of Energy. The U.S. Government may therefore have a paid-up license in this invention and may have the right to require patent owner to license others on reasonable terms as provided for by the terms of the above-identified grant.

### BACKGROUND

Metallofullerenes, also called endohedral metallofullerenes, are a class of molecules composed of metal atoms trapped inside a fullerene cage. Fullerenes in a variety of sizes (i.e., different number of carbon atoms arranged in a cage structure) have been found to encapsulate metal atoms. Simple metallofullerenes consist of a fullerene cage (e.g., C60, C70, C78, C82), with one or two metal atoms trapped inside, such as Gd@C60 and Lu2@C78. The “@” symbol in the formula indicates that the atom(s) are encapsulated inside the cage. More recently, metal-containing molecular clusters have been successfully encapsulated inside a fullerene cage. Metallofullerenes have important optical, magnetic, electronic, and biological properties, and are being researched or developed for use in renewable energy, biomedical imaging, and molecular electronics.

A particularly interesting metallofullerene is called trimetallic nitride metallofullerene, which is a family of metallofullerene molecules containing a closed cage network of carbon atoms with a trimetallic nitride cluster A₃₋ₙXₙN entrapped inside the cage Cₘ. Trimetallic nitride metallofullerene can be represented generally as A₃₋ₙXₙN@Cₘ; where A and X are metal atoms, n=0-2, and m can take on any even values between about 60 and about 200. All elements to the right of a @ symbol are part of the fullerene cage network, while all elements listed to the left are contained within the fullerene cage network. As an example, Sc₃N@C₈₀ indicates that a Sc₃N trimetallic nitride cluster is situated within a C₈₀ fullerene cage. Trimetallic nitride metallofullerene is also known under the trademark Trimetasphere® owned by Luna Innovations Incorporated, Roanoke, Va., U.S. United States Pat. No. 6,303,760, herein incorporated by reference in its entirety, describes this family of metallofullerenes.

### SUMMARY

The present application describes methods for the synthesis of metallofullerenes and devices for making the same. In accordance herewith, high yields and high productivity of metallofullerenes, including trimetallic nitride metallofullerenes, are achieved enabling commercial applications including magnetic resonance imaging contrast agent and organic photovoltaic electron acceptors.

In one embodiment, a method for making metallofullerenes comprising: reacting vaporized carbon and vaporized metal, in the presence of nitrogen-containing process gas, in an alternating current (AC) arc discharge reactor; wherein two or more graphite electrodes are inserted into said reactor. In another embodiment, three graphite electrodes are inserted into said reactor. In yet another embodiment, said graphite electrodes are arranged symmetrically such that there is an angle from 20 degrees to 150 degrees between electrodes. In yet another embodiment, said graphite electrodes are arranged symmetrically such that there is an angle from 35 degrees to 60 degrees between electrodes. In yet another embodiment, the sources of carbon vapor and metal vapor are evaporation in a hot plasma zone of said electrodes packed with said metal or oxide of said metal. In yet another embodiment, the source of carbon vapor is evaporation in arc discharge of at least two solid graphite electrodes, and the source of vapor of said metal is evaporation in arc discharge of the metal powder or the metal oxide powder introduced into the arc discharge independent of said solid graphite electrodes. In yet another embodiment, said powder containing metal or metal oxide is introduced in the arc discharge by powder injection through a nozzle located symmetrically in between electrodes. In yet another embodiment, the nitrogen in said nitrogen-containing process gas is pure nitrogen. In yet another embodiment, said nitrogen-containing process gas consists of pure nitrogen. In yet another embodiment, said powder is selected from a metal powder, a metal oxide powder, or a combination thereof with an admixture from 5% to 50% of powdered carbon. In yet another embodiment, said metallofullerenes are trimetallic nitride metallofullerenes.

Other embodiments include metallofullerenes produced by the disclosed methods and trimetallic nitride metallofullerenes produced by the disclosed methods.

In another embodiment, an apparatus for making metallofullerenes comprising: an arc discharge reactor chamber with suspended water cooled sleeve, and electrode drivers that move graphite electrodes; wherein said reactor is capable of evaporating graphite and metal or metal oxides to initiate a reaction that forms metallofullerenes. In yet another embodiment, said chamber includes devices for imaging of arc discharge process, for enhancing convection, and for removing of produced soot from said chamber. In yet another embodiment, the cold sleeve is suspended vertically inside the reactor chamber in such a manner to allow a gap for the convective flow of a process gas between the reactor chamber walls and the sleeve. In yet another embodiment, internal rotating brushes are used to sweep produced soot from internal walls of said reactor chamber and external wall of said sleeve and to move said soot into an attached soot collector while the reactor is in operation. In yet another embodiment, an image of the hot plasma zone is obtained through a view port which is made as a pinhole camera. In yet another embodiment, said metallofullerenes are trimetallic nitride metallofullerenes.

### BRIEF DESCRIPTION OF THE DRAWINGS

FIG. 1 is a schematic illustration of a setup for the production of endohedral metallofullerenes including trimetallic nitride metallofullerene according to the preferred embodiments, comprising of a single reactor chamber with a suspended cold sleeve, an attached viewport, and a soot collector. This figure also illustrates the configuration of internal gas flows for the 3 phase arc reactor: 1—chamber, 2—sleeve-divertor, 3—gas flow directions, 4—viewport, 5—imaging window, 6—gas and powder injection nozzle, 7, 11—electrodes, 8—plasma jet, 9—electrode tips, 10—converging flow directions, 12—rotating shaft, 13, 14—rotating brushes, 15—exhaust filter, 16—soot collector.

FIG. 2a-2c show HPLC charts for crude Lu₃N@C₈₀ extract of metallofullerene soot produced with three reactor variations: (a) Baseline collinear 2-electrode Direct Current (DC) reactor, packed anode, He/5% N₂ blend process gas at 21 liter/min outflow rate, 300 Torr, 550 A, Lu3N@C80 yield is 0.19 mg/g of soot; (b) 3-phase Alternating Current (AC) arc discharge with packed electrodes, N₂ process gas, 1.5 liter/min outflow rate, 65 Torr, 650 A, Lu3N@C80 yield is 1.4 mg/g of soot; and (c) 3-phase AC arc discharge reactor with solid graphite electrodes, 6.5 g/min Lu₂O₃ powder injection, N₂ process gas, 3.5 liter/min outflow rate, 65 Torr, 700 A, Lu3N@C80 yield is 0.44 mg/g of soot.

FIG. 3 shows the variation of Lu₃N@C₈₀ yields with process gas outflow rate in 3 phase AC discharge setup with packed electrodes. Total outflow rate is He flow rate plus 1 l/min of N₂, reactor pressure 300 Torr, discharge current is 550 A.

FIG. 4 shows the Lu₃N@C₈₀ yield (mg per gram of soot) versus powder feed rate in 3 phase AC discharge with powder feed: pressure 60-80 Torr of N₂, gas flow rate 2.4-3.5 l/min, a feedstock is recycled Lu₂O₃+10% of carbon flakes, current 750A, 1″ solid graphite electrodes.

FIG. 5a-5b show HPLC charts for crude Gd₃N@C₈₀ extract of metallofullerene soot produced with two reactor variations: (a) Baseline collinear 2-electrode DC arc discharge, Gd₂O₃/C packed electrode, He/N₂=20/1 blend process gas, 21 l/min flow rate, Gd3N@C80 yield is 0.02 mg/g of soot; and (b) 3 phase AC arc discharge, solid graphite electrodes, Gd₂O₃ powder feed, N₂ process gas, flow rate 7.2 l/min, Gd3N@C80 yield is 0.043 mg/g of soot.

### DETAILED DESCRIPTION OF THE PREFERRED EMBODIMENTS

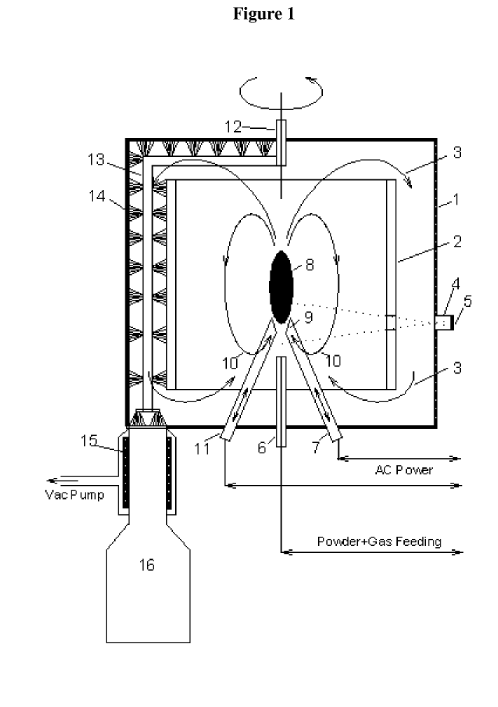

FIG. 1 is the detailed schematic illustration of an apparatus for the production of metallofullerenes, including but not limited to trimetallic nitride metallofullerenes, according to the preferred embodiments described herein.

The apparatus in FIG. 1 is based on the vacuum tight, water cooled arc discharge reactor chamber 1, which comprises the water cooled cylindrical sleeve 2, the graphite electrodes 7, 11 with electrode drivers, the powder injection nozzle 6, the rotating brushes 13, 14, the viewport 4, the exhaust filter 15 and the soot collector 16.

The reactor chamber 1 is filled by nitrogen-containing process gas. The term “nitrogen-containing process gas” as used herein means a process gas comprising nitrogen gas. Thus, “nitrogen-containing process gas” may include nitrogen gas alone as the process gas or the process gas may be nitrogen gas in combination with or as an admixture of other gases, including but not limited to noble gas(es) such as helium. In an exemplary embodiment the process gas contains no admixture of any noble gas. In yet another embodiment the process gas only contains pure nitrogen gas. The chamber comprises at least two isolated packed or solid graphite electrodes 7 and 11. In an exemplary embodiment the chamber comprises three isolated packed or solid graphite electrodes. In yet another embodiment the chamber comprises three solid graphite electrodes.

The electrodes are arranged such that there is an angle from 20 degrees to 150 degrees between them. In another exemplary embodiment there is an angle from 30 degrees to 90 degrees between the electrodes. In yet another embodiment there is an angle from 35 degrees to 60 degrees between the electrodes.

By applying alternating current (AC) potential across the electrodes, a high power arc discharge is produced in between graphite electrode tips 9. An arc discharge evaporation of said tips is a source of carbon vapor for the reaction of metallofullerene formation. The arc discharge creates also a plasma zone around electrode tips 9.

An image of the arc discharge process and vertical positions of the electrode tips 9 are monitored at the viewport 4 made as pinhole camera. A light from reactor chamber passes through a small hole into the viewport 4. The hole works as an aperture of a pinhole camera. The image is projected onto translucent window 5. Along with safe viewing without any dark filter, the hole attenuates also a soot flux coming from the reactor chamber 1. The residue soot flux is fully blocked by the small gas outflow applied to viewport 4.

The stability of arc discharge is maintained by two parallel electrode position control modes. The first mode—an automatic and synchronous adjustment of the axial position of all electrodes until a minimal value among in-between-electrodes potentials is equal to set point. Then if an evaporation rate of each electrode is ideally the same, the electrodes tips 9 positions will be located in one horizontal plain stationary and symmetrically. In practice there are small differences in evaporation rate among the electrodes. Then a tip position of the electrode, whose evaporation rate is less than the average, will move upward under the first mode control only. The second mode—when, using the viewport 4, a substantial deviation in the tip position is detected visually or automatically by the image processing then the particular electrode is adjusted to the symmetrical position separately.

In an exemplary embodiment, trimetallic nitride metallofullerenes are synthesized by reactions between carbon, metal, and nitrogen. A reaction of trimetallic nitride metallofullerene synthesis may take place when all ingredients are in an atomic form. Due to very high temperature any solid particles in the plasma zone start to evaporate and any involved vapor of molecular compounds will be decomposed or atomized, including metal oxides and molecular nitrogen. Thus, dissociation of nitrogen content of process gas in the plasma zone is a source of atomic nitrogen for the reaction of trimetallic nitride metallofullerene formation. The metal to be incorporated into the carbon cage of the trimetallic nitride metallofullerene is injected into the reactor chamber 1 through the injection nozzle 6 in the form of metal powder or metal oxide powder, with subsequent evaporation and decomposition of powder particles in said plasma zone.

To reduce a bridging effect and for better mobility, an admixture from 5% to 50% of powdered carbon, is added to the injecting powder. In an exemplary embodiment there is an admixture from 6% to 25% of powdered carbon. Along with the evaporation of graphite tips 9 this admixture evaporation is also one source of carbon for metallofullerene synthesis.

The synthesis process is accomplished by quenching of the reaction products by means of fast cooling and quick removal from the plasma zone.

Due to the specially arranged angle position between electrodes the plasma zone of the arc discharge resembles a high velocity plasma jet 8. The plasma jet is induced by Lorentz force which is a result of an interaction of the current (I), passing through the plasma, with an associated magnetic field (B). Both the magnitude and direction of this force is described by the vector cross product F=[I×B] (Lorentz Law). The force vector is positioned on the bisector of the angle between electrodes and always directed away from the electrode tips 9. The force creates an internal gas pump which drives the plasma jet 8.

In the presence of the high velocity plasma jet, the reaction products are removed from the plasma zone very quickly. The quenching and cooling rates are high enough to maintain the high metallofullerene yield using process gas with very low or zero helium content, preferably no helium.

High efficiency of powder injection suggested that a large portion of total injected powder particles reaches the hot plasma zone and be subsequently evaporated. In the presence of high velocity plasma jet the resulted gas flow, as superposition of the plasma jet 8 and developed convection, is marked by the gas flow lines 3, 10. The converging gas flow lines 10 at the tip of the nozzle 6 create “a focusing lens” for any injected powder particles and therefore highly efficient powder injection takes place. All powder particles coming from nozzle 6 are caught by the converging gas flows and delivered into the arc discharge with a probability >95%.

The water cooled sleeve 2 suspended inside the reactor chamber 1 doubles the cold surface area available for deposition of the produced soot and for cooling of the process gas. A wide cold cylindrical gap between the reactor chamber and said sleeve intensifies process gas convection in the reactor and reduces a residence time of reaction products in gaseous flow. Due to cooling in the gap of a process gas, carrying fine soot particles, the particle density and therefore coagulation and sedimentation rate of soot are increased. At the same time the produced soot, deposited on the external wall of said sleeve and the internal cylindrical wall of reactor chamber 1, is protected by said sleeve from overheating by an intense radiation flux coming from the arc discharge.

A long reactor run produces thick soot sediment on reactor walls, which reduces cooling capacity of cold surfaces. To eliminate this negative effect, the internal brushes 13, 14, rotated by the shaft 12 are used to sweep a layer of soot from the upper flange and internal cylindrical wall of the reactor chamber 1 and from the external wall of the sleeve 2. The swept soot is moved further by the caudal end of the brushes into soot collector 16 through a hole in reactor chamber's bottom flange.

### EXAMPLES

### Example 1

### Synthesis of Metallofullerene Lu₃N@C₈₀ Using Evaporation of Packed Electrodes in 3-Phase AC Reactor

The synthesis of Lu₃N@C₈₀ was performed in the 3-phase arc discharge reactor using alternating current (AC) as described in FIG. 1. The reactor had three 1″ diameter electrodes that are arranged symmetrically such that there is an angle of 40 degrees between electrodes. 3-phase arc discharge was initiated and maintained by 3-phase 46 kW power supply.

Lu₃N@C₈₀ yield was measured by HPLC method. All HPLC measurements were made using Shimadzu SPD-10 HPLS System with Cosmosil Buckyprep analytical column and xylene as the eluent.

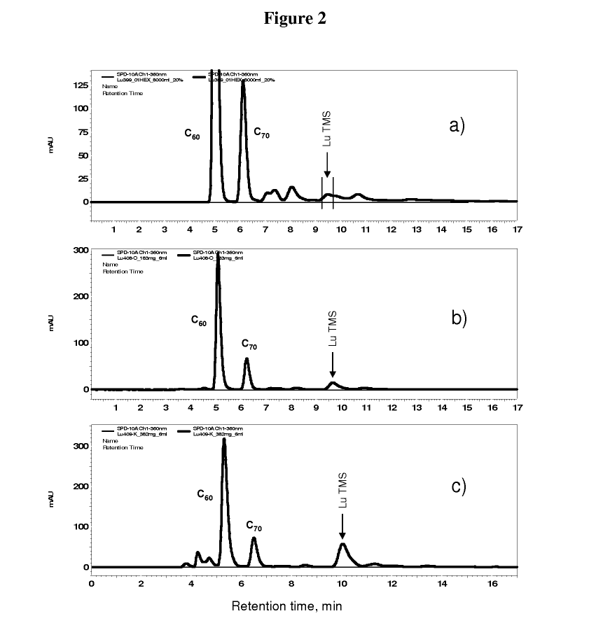

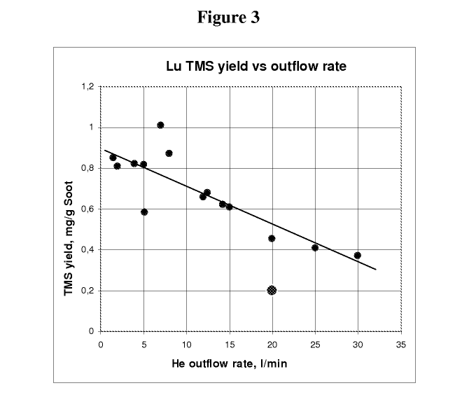

The reactor had three 1″ packed electrodes which were prepared by drilling 1″ graphite rod and filling them by a mixture of Lu₂O₃ and carbon powders. Lu₂O₃ loading was 50%. Pure nitrogen as the process gas was used at pressure 60 Torr and flow rate 1.5 l/min. The soot production rate was 5 g/min at discharge current 750 A. The produced soot was extracted using xylene. HPLC analysis (FIG. 2b) of the crude extract showed the presence of Lu₃N@C₈₀ with the yield 1.4 mg/gram of soot. The 3-phase AC arc reactor demonstrated approximately 8-fold improvement in Lu3N@C80 yield compared to the conventional collinear two-electrode direct current (DC) arc reactor with a yield of 0.19 mg/g of soot (FIG. 2a). FIG. 3 shows the relationship of Lu₃N@C₈₀ yield with process gas flow rate indicating that the highest yield was achieved without helium.

### Example 2

### Synthesis of Lu₃N@C₈₀ Using Evaporation of Solid Electrodes and a Powder Injection

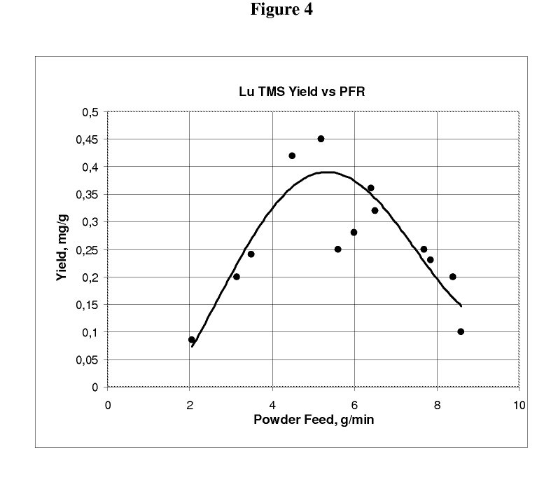

The synthesis of Lu₃N@C₈₀ was performed in the arc discharge reactor using alternating current (AC) as described in FIG. 1. The reactor had three 1″ diameter electrodes that are arranged symmetrically such that there is an angle of 38 degrees between electrodes. The reactor had three solid 1″ graphite electrodes. The Lu metal to be incorporated in carbon cage was introduced into the plasma by injection of Lu₂O₃ powder through the nozzle 6. The powder injection rate was 5.5 g/min. The pure nitrogen as the process gas was used at pressure 60 Torr and the flow rate 3.5 l/min. The soot production rate was 8 g/min at discharge current 780 A. The produced soot was extracted using xylene. HPLC analysis (FIG. 2c) of the crude extract showed the presence of Lu₃N@C₈₀ with the yield 0.44 mg/gram of soot. FIG. 4 shows the Lu₃N@C₈₀ yield variation with the powder feed injection rate and the highest yield was achieved with ˜5 grams per minute of powder feed rate.

### Example 3

### Synthesis of Gd₃N@C₈₀ Using Evaporation of Solid Electrodes and a Powder Injection

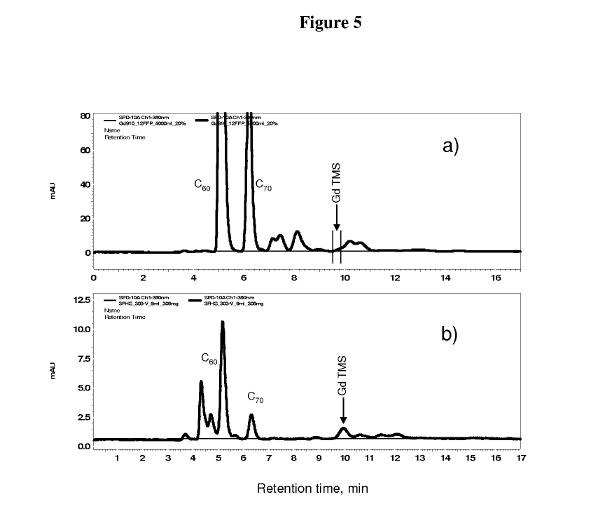

The synthesis of Gd₃N@C₈₀ was performed in the three phase arc discharge reactor using alternating current (AC) as described in FIG. 1. The reactor had three 1″ diameter solid graphite electrodes that are arranged symmetrically such that there is an angle of 42 degrees between electrodes. Gadolinium was introduced into the plasma by injection of Gd₂O₃ powder through the nozzle. The powder injection rate was 4.9 g/min. The pure nitrogen as the process gas was used at pressure 70 Torr and flow rate 2.4 l/min. The soot production rate was 6.4 g/min at discharge current 750 A. The produced soot was extracted using xylene. HPLC analysis (FIG. 5b) of the crude extract showed the presence of Gd₃N@C₈₀ with the yield 0.043 mg/gram of soot, which demonstrates a 2-fold improvement compared to the conventional collinear two-electrode direct current (DC) arc reactor with a yield of 0.02 mg/g of soot (FIG. 5a).

The foregoing description provides illustration and description, but is not intended to be exhaustive or to limit the invention to the precise form disclosed. Modifications and variations are possible in light of the above teachings or may be acquired from practice of the invention.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, unless otherwise stated, all ranges are inclusive, divisible, and combinable.

All of the above-mentioned references are herein incorporates by reference in their entirety to the same extent as if each reference was specifically and individually indicated to be incorporates herein by reference in its entirety.

1. A method for making metallofullerenes comprising:
reacting vaporized carbon and vaporized metal, in the presence of nitrogen-containing process gas, in an alternating current (AC) arc discharge reactor;
wherein two or more graphite electrodes are inserted into said reactor.

2. The method of claim 1, wherein three graphite electrodes are inserted into said reactor.

3. The method of claim 1, wherein said graphite electrodes are arranged symmetrically such that there is an angle from 20 degrees to 150 degrees between electrodes.

4. The method of claim 1, wherein said graphite electrodes are arranged symmetrically such that there is an angle from 35 degrees to 60 degrees between electrodes.

5. The method of claim 1, wherein the sources of carbon vapor and metal vapor are evaporation in a hot plasma zone of said electrodes packed with said metal or oxide of said metal.

6. The method of claim 1, wherein the source of carbon vapor is evaporation in arc discharge of at least two solid graphite electrodes, and the source of vapor of said metal is evaporation in arc discharge of the metal powder or the metal oxide powder introduced into the arc discharge independent of said solid graphite electrodes.

7. The method of claim 6, wherein said powder containing metal or metal oxide is introduced in the arc discharge by powder injection through a nozzle located symmetrically in between electrodes.

8. The method of claim 1, wherein the nitrogen in said nitrogen-containing process gas is pure nitrogen.

9. The method of claim 8, wherein said nitrogen-containing process gas consists of pure nitrogen.

10. The method of claim 6, wherein said powder is selected from a metal powder, a metal oxide powder, or a combination thereof with an admixture from 5% to 50% of powdered carbon.

11. The method of claim 1, wherein said metallofullerenes are trimetallic nitride metallofullerenes.

12. Metallofullerenes produced by the method of claim 1.

13. Trimetallic nitride metallofullerenes produced by the method of claim 11.

14. An apparatus for making metallofullerenes comprising:
an arc discharge reactor chamber with suspended water cooled sleeve, and electrode drivers that move graphite electrodes;
wherein said reactor is capable of evaporating graphite and metal or metal oxides to initiate a reaction that forms metallofullerenes.

15. The apparatus of claim 14, wherein said chamber includes devices for imaging of arc discharge process, for enhancing convection, and for removing of produced soot from said chamber.

16. The apparatus of claim 14, wherein the cold sleeve is suspended vertically inside the reactor chamber in such a manner to allow a gap for the convective flow of a process gas between the reactor chamber walls and the sleeve.

17. The apparatus of claim 14, wherein internal rotating brushes are used to sweep produced soot from internal walls of said reactor chamber and external wall of said sleeve and to move said soot into an attached soot collector while the reactor is in operation.

18. The apparatus of claim 14, wherein an image of the hot plasma zone is obtained through a view port which is made as a pinhole camera.

19. The apparatus of claim 14, wherein said metallofullerenes are trimetallic nitride metallofullerenes.
